(19) United States
(12) Patent Application Publication
(10) Pub. No.: US 2009/0028183 A1
(43) Pub. Date: Jan. 29, 2009

(54) Platform for communicating across multiple communication channels

(76) Inventors: William P. Landers, Akron, OH (US); Brian Deagan, Akron, OH (US); Jonathon L. Grimm, Moreland Hills, OH (US); Taras Novak, Indian Creek, IL (US)

Correspondence Address: MCDONALD HOPKINS LLC, 600 Superior Avenue, East, Suite 2100, CLEVELAND, OH, 44114-2653, US

(21) Appl. No.: 12/157,218

(22) Filed: Jun. 9, 2008

Related U.S. Application Data
(60) Provisional application No. 60/942,659, filed on Jun. 7, 2007.

(51) Int. Cl. H04J 3/22

(52) U.S. Cl. 370/466

(57) ABSTRACT

Systems, methods, and other embodiments associated with communications through a software platform are described herein. In an embodiment, a method for communicating with users across multiple communication channels from a single platform includes gathering data related to a first user; storing the gathered data; accessing the stored data to determine whether a message should be sent to the first user; accessing the stored data to determine what communication channel should be used to send the message to the first user; formatting the message for the determined communication channel; and sending the message to the first user through the determined communication channel.

### CROSS-REFERENCE TO RELATED APPLICATIONS

This application claims priority from U.S. Provisional Patent Application No. 60/942,659 entitled “PLATFORM FOR COMMUNICATING ACROSS MULTIPLE COMMUNICATION CHANNELS,” filed on Jun. 7, 2007, which is hereby incorporated by reference in its entirety.

### FIELD OF INVENTION

The present invention relates generally to communications through a software platform and, more particularly, to methods and systems for formatting and delivering targeted and optimized communications through multiple online communication channels from a single software platform.

### BACKGROUND

Companies often spend substantial amounts of time, money, effort and other such resources developing multiple channels to communicate with groups of people, such as existing consumers and potential customers. Companies often implement methods, hardware, and software that are unique to a given channel of communication. In addition, companies may dedicate specific employees to manage a single channel of communication. For example, a company may assign a team to implement and manage a software package that communicates with customers in a targeted manner on their website. The same company may assign a different team to implement and manage a different software package that communicates with customers through electronic mail messages. Such an arrangement typically causes duplication of work and an inconsistent message to customers. This duplication of work is inefficient and may cause unnecessary increases in the company's expenses. Inconsistent and uncoordinated messages through the various channels may create poor online experiences and cause confusion for customers as well, resulting in lost sales and revenue for the company.

### SUMMARY OF INVENTION

Systems, methods, and other embodiments associated with communications through a software platform are described herein. In an embodiment, a method for communicating with users across multiple online communication channels includes gathering data related to a first user; storing the gathered data; accessing the stored data to determine whether a message should be sent to the first user; accessing the stored data to determine what communication channel should be used to send the message to the first user; formatting the message for the determined communication channel; and sending the message to the first user through the determined communication channel.

### BRIEF DESCRIPTION OF THE DRAWINGS

The accompanying drawings, which are incorporated in and constitute a part of the specification, illustrate various example systems, methods, and other example embodiments of various aspects of the invention.

FIG. 1 schematically illustrates an embodiment of a communication platform;

FIG. 2 schematically illustrates an embodiment of a communication platform;

FIG. 3 illustrates an exemplary method of employing a communication platform;

FIG. 4 schematically illustrates an embodiment of a communication platform;

FIG. 5 illustrates an exemplary method of employing a communication platform;

FIG. 6 illustrates an exemplary method of employing a communication platform;

FIG. 7 illustrates an exemplary method of employing a communication platform; and

FIG. 8 illustrates an exemplary method of employing a communication platform.

### DETAILED DESCRIPTION

Example systems, methods, media, and other embodiments described herein relate to providing a platform for communication with a group of people through multiple communication channels. In one example, a single platform is provided to facilitate a company's communications with existing customers or potential customers across multiple channels such as, for example, electronic mail, mobile telephone, internet website, and interactive television communication channels.

In an embodiment, systems and methods are provided that merge the management of a company's disparate communication channels. Such novel systems and methods may be directed to providing a single platform for communication with existing customers and potential customers across disparate communication channels. A single platform may reduce costs and increase the consistency of a company's communications with its customers. In other embodiments, the platform provided may be a unified platform, a shared platform, a commonly accessible platform, or the like.

The following includes definitions of selected terms employed herein. The definitions include various examples and/or forms of components that fall within the scope of a term and that may be used for implementation. The examples are not intended to be limiting. Both singular and plural forms of terms fall within the scope of these definitions.

“Application,” as used herein, refers to a set of related computer-executable instructions that may be executed on a computer or a computer infrastructure to achieve a defined goal. An application may be a stand-alone application, a distributed application, a client-server application, an internet-enabled application, and so on. An application may have interface logic and business logic that may be distributed on different computers.

“Computer component,” as used herein, refers to a computer-related entity such as hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer communication,” as used herein, refers to a communication between two or more computing devices (e.g., computer, personal digital assistant, mobile telephone) and can be, for example, a network transfer, a file transfer, an applet transfer, an electronic mail, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

“Data store,” as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic,” as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), an analog circuit, a digital circuit, a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection,” or a connection by which entities are “operably connected,” is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be considered to be operably connected if they are able to communicate signals to each other directly or through one or more intermediate entities like a processor, an operating system, a logic, software, or other entity. Logical and/or physical communication channels can be used to create an operable connection.

“Query,” as used herein, refers to a semantic construction that facilitates gathering and processing information. A query may be formulated in a database query language like structured query language (SQL) or object query language (OQL). A query may also be implemented in computer code (e.g., C#, C++, Javascript) that can be employed to gather information from various data stores and/or information sources.

“Software,” as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may depend, for example, on requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel, and other manners.

Software suitable for implementing the various components of the example systems and methods described herein may include software produced using programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

Example methods may be better appreciated with reference to flow diagrams. While, for purposes of simplicity of explanation, the illustrated methodologies are shown and described as a series of blocks, it is to be appreciated that the methodologies are not limited by the order of the blocks, as some blocks can occur in different orders and/or concurrently with other blocks from those shown and described. Moreover, less than all of the illustrated blocks may be required to implement an example methodology. Blocks may be combined or separated into multiple components. Furthermore, additional and/or alternative methodologies can employ additional blocks not illustrated. While the figures illustrate various actions occurring in serial, it is to be appreciated that, in different examples, various actions could occur concurrently, substantially in parallel, and/or at substantially different points in time.

Systems and methods for providing a platform to facilitate communications with groups of people are disclosed herein. In one embodiment, a platform provides for communication with groups of people across multiple communication channels. Examples of such communication channels include, but are not limited to, electronic mail communication channels, mobile telephone communication channels, internet website communication channels, and interactive television communication channels.

In an embodiment, a platform and methods of using a platform are arranged to provide highly relevant and customized marketing information to targeted customers through multiple communication channels. Such customized marketing information may be provided to customers of nearly any industry such as, for example, retail, financial, travel, hospitality, telecommunications, publishing, non-profit, and entertainment industries.

Generally, communication across an electronic mail (“e-mail”) communication channel includes sending electronic communications to and receiving electronic communications from e-mail accounts accessible by a computing device such as a personal computer, a personal digital assistant, or a mobile phone. Such communications may include text, graphics images, animated images, hyperlinks, audio files, and the like. In one example of communication between a company and a customer across an e-mail channel, a financial institution, such as a bank, sends e-mail to a customer's e-mail account to inform the customer that the balance in the customer's checking account is nearing the minimum balance allowed for the account.

Generally, communication across a mobile telephone communication channel includes sending digital or analog communications to and receiving such communications from a mobile telephone device. Such communications may include, but are not limited to, audio, text messages, graphic images, animated images, and the like. In an example of communication between a company and a customer across a mobile phone channel similar to that described above, a bank sends a text message or prerecorded audio message to a customer's mobile phone to inform the customer that the balance in the customer's checking account is nearing the minimum balance allowed for the account.

Generally, communication across an internet website communication channel includes sending digital communications to and receiving digital communications from a visitor to a website whom has accessed the website through the internet. Such communications may include statically or dynamically populating a pop-up window or a portion of website real estate with text, graphic images, animated images, streaming video, and the like. In an example of communication between a company and a customer across an internet website channel similar to that described above, a bank dynamically populates a portion of its website when a customer visits its website to inform the customer that the balance in the customer's checking account is near the minimum balance allowed for the account.

It will be readily understood by persons skilled in the art upon reading and understanding this disclosure that multiple communication channels may send communications to and receive communications from a single device. For example, a single device such as an internet-enabled multimedia mobile phone may communicate with a platform across the e-mail communication channel, the mobile telephone communication channel, the internet website communication channel, and even the interactive television communication channel.

Although certain communication channels have been described herein in detail, such channels are exemplary only and in no way are intended to limit this disclosure. It will be readily understood that any communication channel, whether it be digital, electronic, analog, or the like, may be practiced with the embodiments disclosed herein.

With further reference to the aforementioned example of a bank informing a customer that an account is nearing the minimum balance allowed, the multiple channels of communications may be managed through a single platform to provide the customer with such a warning in the manner in which the customer prefers to receive that warning. For example, the bank may initiate communications with a new customer by sending a newsletter to an e-mail account provided by a new customer. The newsletter may be personalized or customized to include information that is highly relevant to the customer. For example, if the customer is a college student, the newsletter may include informative articles on areas of expected growth in the employment market or methods of minimizing the need for student loans. If the customer is well established in the work force, the newsletter may include articles regarding maximizing retirement savings or investment vehicles for saving money to pay for a child's future college expenses.

The newsletter may include an option through which the customer may request or opt-in to a number of automatic alerts. The alerts also may be customized or personalized for the customer. Such alerts may include a minimum account balance alert, alerts informing the customer of changes in certified deposit or money market rates, alerts informing the customer of changes in student loan consolidation rates, and the like. Upon requesting an alert, the customer may select the preferred method for delivering an alert. For example, a customer that has access to e-mail during the majority of each business day, such as an office worker, may prefer that an alert be delivered to a work e-mail account. A customer who has sporadic access to e-mail but has continuous access to a mobile phone, such as a salesperson or college student, may prefer to have an alert sent to a mobile phone.

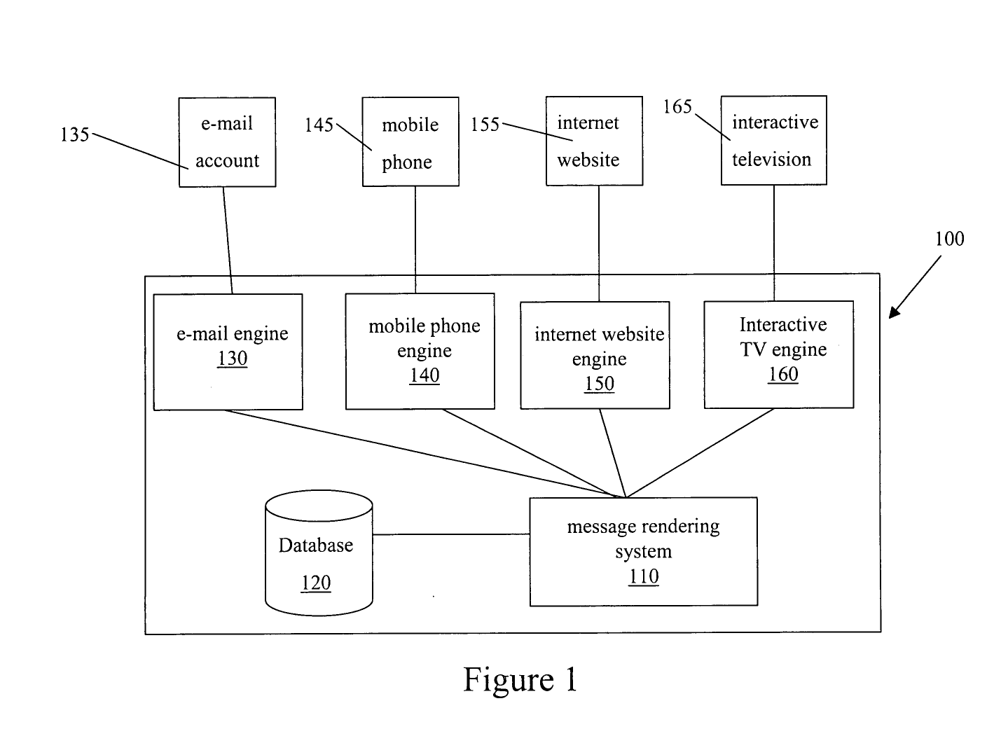

In an embodiment, the example provided above may be implemented by providing the bank with a single platform to manage communications with its customers across multiple channels. An exemplary illustration of such a platform 100 is shown in FIG. 1. The platform includes a message rendering system 110, a data store 120, and multiple delivery engines to facilitate communications through multiple communication channels. In the embodiment illustrated, the data store 120 is a database that is in communication with the message rendering system 110. The message rendering system 110 is in communication with the multiple delivery engines.

In the example illustrated in FIG. 1, an e-mail delivery engine 130 is provided to deliver communications to and receive communications from e-mail accounts 135 through e-mail channels, a mobile phone engine 140 is provided to deliver communications to and receive communications from a mobile or cellular phone 145 through mobile phone channels, an internet website delivery engine 150 is provided to deliver communications to and receive communications from websites 155 through internet website channels, and an interactive television delivery engine 160 is provided to deliver communications to and receive communications from an interactive television device 165 through interactive television channels. In an embodiment, one or more of the delivery engines may be optional. In such an embodiment, the message rendering system 110 may be arranged to communicate directly with e-mail accounts 135, mobile phones 145, websites 155, and interactive television devices 165.

Although the platform 100 of FIG. 1 shows four communication channels, it will be readily understood by those of ordinary skill in the art that more than four or less than four communication channels may be included. The platform 100 may be arranged to be flexible or expandable so that additional communication channels may be added as needed or as technology advances and more channels are developed. In addition, the communication channels illustrated and discussed herein are only a subset of communication channels that may be practiced with the embodiments described herein and their equivalents.

The platform 100 is arranged such that, regardless of which communication channel is used, the content of the communication is generated, managed, and rendered by the message rendering system 110 and the database 120. The database 120 is arranged to store data regarding customers and communications with those customers. For example, a customer's age, a customer's profession, the identification number of accounts owned by a customer, the balances on those accounts, and which alerts a customer requested may be stored in the database 120.

The platform 100 is arranged such that the message rendering system 110 is utilized to manage communications across the multiple channels. The message rendering system 110 is an application that may run on either a single server or multiple servers. For example, in an embodiment, the message rendering system 110 is spread across five servers to create redundancy and maximize performance of the platform 100. The platform 100 is arranged as a single platform even when multiple servers are utilized or such servers are positioned in disparate locations.

In an embodiment, the message rendering system 110 includes logic that queries the database 120 and performs actions based on the results of the query. The logic may include rules that receive data as input and output instructions to generate actions, such as initiating a communication with a customer across a communication channel. It will be understood that the database 120 may be arranged also to include logic to generate queries. The message rendering system 110 also may be arranged such that data may be stored within the system 110 or subcomponents of the system 110.

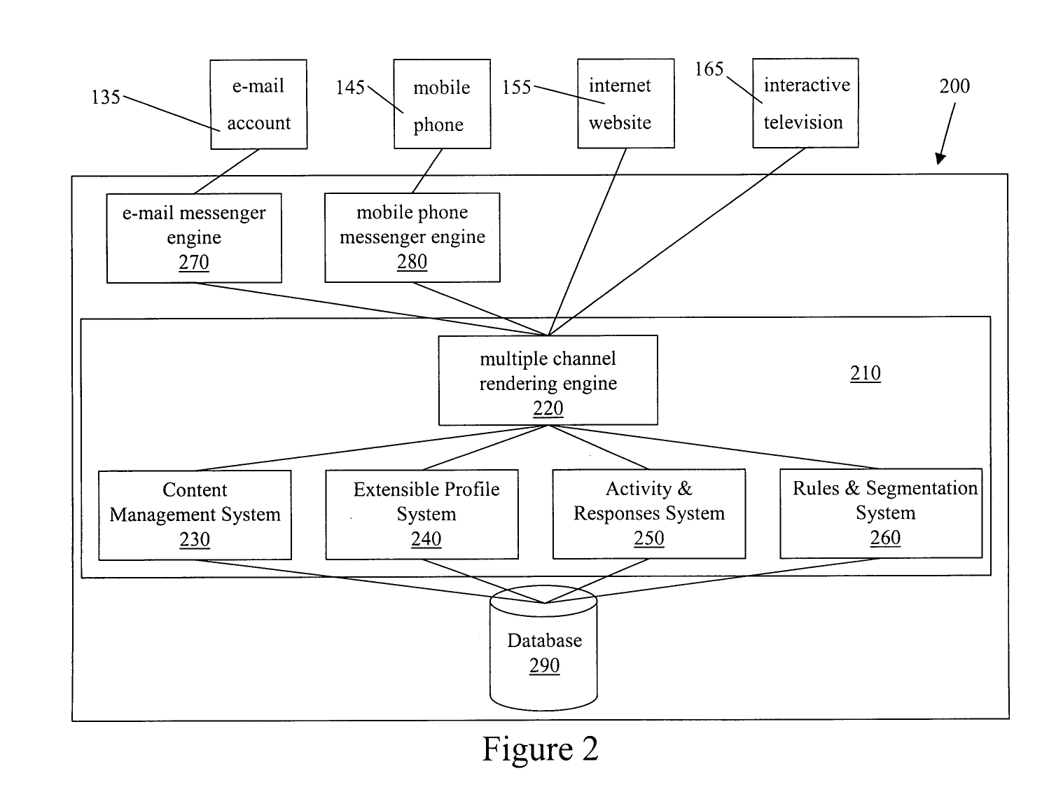

Another exemplary illustration of a platform 200 is shown in FIG. 2. As shown in FIG. 2, the message rendering system 210 comprises a number of subsystems. Such subsystems include a multiple channel rendering engine 220, a content management system 230, an extensible profile system 240, an activity and response system 250, and a rules and segmentation system 260. The platform 200 further includes an e-mail messenger engine 270 and a mobile phone messenger engine 280 in communication with the multiple channel rendering engine 220 to facilitate communication with e-mail accounts 135 and mobile phones 145. As is illustrated, the multiple channel rendering engine 220 is arranged to communicate directly with websites 155 and interactive TV devices 165. The platform 200 also includes a database 290 in communication with subsystems of the message rendering system 210.

The multiple channel rendering engine 220 includes logic for assembling, building, or rendering messages for all communication channels. The logic also includes functionality for querying the content management system 230, the extensible profile system 240, the activity and response system 250, and the rules and segmentation system 260 for data, rules, conditions, and other such information required to properly assemble messages. The logic also includes functionality for communicating messages through communication channels, either directly through a communication channel or through a messenger engine.

The content management system 230 may be arranged to store all content components used to assemble message such as, for example, text, graphic images, video, animated graphics, audio files, hyperlinks, and the like. Such content components may be accessed or queried by the multiple channel rendering engine 220 to assemble unique messages for each communication channel. In one example, the rendering engine 220 may assemble messages for delivery through multiple channels to alert a customer that an account is nearing a minimum allowable account balance. When such an alert is to be delivered through the e-mail communication channel, the rendering engine 220 may query the content management system 230 to obtain text strings to assemble a message describing the situation (i.e., “Your checking account is within $20.00 of its minimum allowable balance.”), a graphic image of a red warning sign, and a general hyperlink to the bank's website where account activity may be viewed and funds transferred between accounts. The message rendering engine 220 may now assemble a highly relevant and useful e-mail message by using the text string to inform the customer of the issue, using the red warning sign graphic to indicate to the customer the nature and urgency of the e-mail, and offering the hyperlink so that the customer may quickly access the bank website, check activity in the bank account in question, and transfer funds if necessary.

When a minimum account balance alert is to be delivered through a mobile phone communication channel, the rendering engine 220 may query the content management system 230 to retrieve short message service (SMS) messages or multimedia message service (MMS) messages that describe the potential issue and provide a customer service number for the customer to call to gather information regarding the account. Such messages may be assembled into a highly relevant and useful communication to send to the customer's mobile phone. In another example, the rendering engine 220 may query the content management system 230 to obtain a first audio file describing the potential issue and a second audio file providing a customer service number to assembly and send to the customer's mobile phone. In yet another embodiment, the rendering engine 220 may query the content management system 230 to obtain a first text file describing the potential issue and a second text file providing a customer service number to assembly and send the text message to the customer's mobile phone.

The extensible profile system 240 may be arranged to store core profile data and information regarding a customer such as, for example, a customer's name, home address, home phone number, e-mail addresses, mobile telephone number, age, gender, and the like. The extensible profile system 240 is extensible in that the core data chosen for storage in the system 240 may be variable. For example, a bank may include the name and type of accounts owned by the customer in the core profile data stored in the profile, while a retailer may include a shipping address used by the customer for previous purchases in the core profile data stored in the system 240. In the example of a minimum account balance alert, as the message rendering engine 220 assembles a message, the engine 220 may query the extensible profile system 240 for core profile data to complete and send the message. For example, the rendering engine 220 may query the profile system 240 to retrieve the customer's first name to personalize an e-mail and to retrieve the customer's e-mail address to properly send an e-mail through an e-mail communication channel.

The activity and response system 250 may be arranged to store a customer's activity and responses over time. For example, when a customer is visiting a website, the customer may perform searches for products or click on hyperlinks to access specific web content. This web activity may be stored in the activity and response system 250 and may be retrieved by the message rendering engine 220 to further customize messages to provide highly relevant content in messages to a customer. Through e-mail communication, a customer may respond to specific questions, and such responses may be stored in the activity and response system 250 and associated with the customer. In addition, while visiting a website, a customer may be presented with a survey, poll, or other such question-based form. When a customer opts to complete the survey or poll, the responses to the questions presented may be stored in the system 250 and associated with the customer. In the example of a minimum account balance alert, prior to the message rendering engine 220 assembling a message, the engine 220 may query the activity and response system 250 to determine if the customer has requested that an alert be sent when an account is nearing its minimum balance. If the customer has requested such an alert, the query may also retrieve information on the preferred channel for communicating such an alert. Based on this retrieved information, the message rendering engine 220 may proceed with formatting the information for the desired communication channel and send the message, or the engine 220 may end the process if the customer has not requested alerts.

The rules and segmentation system 260 includes content rules and segmentation conditions written to maximize the efficiency and effectiveness of messages communicated by the platform 200. Content rules and segmentation conditions may be written to determine, for example, which customers should receive messages, the timing for sending messages, the content of messages, etc. The rules and conditions may be written to create lists of customers based on core profile information stored in the extensible profile system 240 and activity and response information stored in the activity and response system 250.

In an example, a marketing campaign may be launched to promote the sales of an electronic device such as an MP3 player. Rules may be written to create a list of customers most likely to purchase an MP3 player. In such an example, the rules may require the message rendering system 220 to query the extensible profile system 240 to return a list of customers that fit a demographic that is known to be generally interested in electronic devices, such as males between the ages of 20 and 35. The rules may further require that the message rendering system 220 query the activity and responses system 250 to evaluate the activity and responses for all customers on the newly-developed list. If the activity and responses of a customer make it likely that the customer will purchase an MP3 player, the customer is retained on the list. If the activity and responses make it unlikely that the customer will purchase an MP3 player, the customer is removed from the list. Customer activity, such as recent website searches for devices similar to an MP3 player, may be an activity that increases the probability that the customer will purchase an MP3 player if a promotional message is communicated to the customer through one or more of the communication channels.

Once a list of customers likely to purchase an MP3 player is finalized, the message rendering engine 220 may query or otherwise further interact with the content management system 230, the extensible profile system 240, the activity and response system 250, and the rules and segmentation system 260 to assemble, customize, and send messages to customers across multiple channels. Messages to consumers may be assembled in a variety of ways. In an example, a single generic message template is provided as the base of all messages sent to consumers on the list. Prior to sending the message, the message rendering engine 220 personalizes and customizes the generic message template for each customer. In another example, multiple generic message templates are provided. The message rendering engine 220 selects the best template for each customer and provides customization and personalization based on the customer's stored profile.

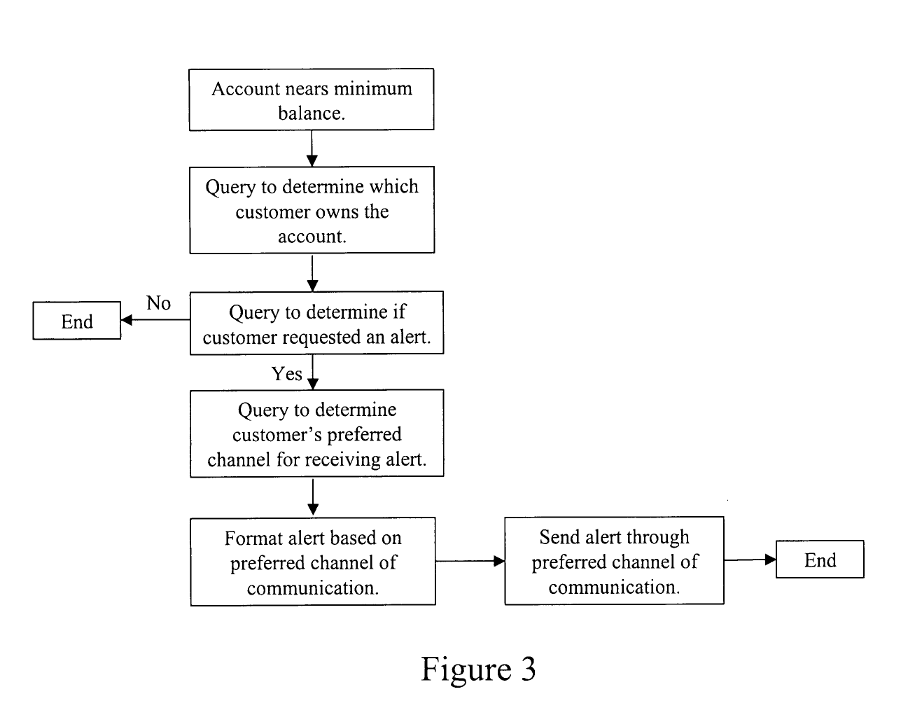

As illustrated by the flowchart of FIG. 3, methods may be provided to apply rules to customer profiles to initiate communications with a customer. In the exemplary method shown in FIG. 3, as an account nears its minimum balance, logic in the message rendering system 220 may query information and data stored in the extensible profile system 240, the activity and response system 250, and the database 290 to determine if a communication should be initiated. The query may determine the name of the customer who owns the account and whether that customer has requested a minimum balance alert. If it is determined that the customer has requested a minimum balance alert, a query may further determine the channel of communication preferred by the customer for delivery of the minimum balance alert. The query may also return the customer's e-mail account address, mobile phone number, etc.

Rules in the rules and segmentation system 260 may be evaluated to confirm that a message should be communicated to this particular customer. Once it is determined that a message should be communicated, logic in the multiple channel rendering engine 220 may then access graphics, text, audio files, and the like from the content management system 230 to appropriately format an alert for the customer's preferred channel. The multiple channel rendering engine 220 may then deliver the alert either directly or through the appropriate delivery engine 270, 280. In one example, if a customer prefers an e-mail alert, the multiple channel rendering engine 220 may access text and graphics from the content management system 230 to format an e-mail alert, and the alert may be delivered to the customer's e-mail account through the e-mail delivery engine 270. In another example, if the customer prefers that an alert be sent to the customer's mobile phone, the multiple channel rendering engine 220 may access an SMS message, an MMS message, or an audio file from the content management system 230 to construct a text message alert or an audio alert to be sent to the customer's mobile phone through the mobile messenger engine 280.

Optionally, methods may include steps to ensure that the customer receives a desired alert. For example, if e-mail is sent to the customer, and the platform 100, 200 detects that the e-mail was not accepted by the e-mail account or was inadvertently blocked by a spam filter, a duplicate message may be sent to the customer's mobile phone to ensure the customer receives the alert. Similarly, if an initial text message is not received by a mobile phone, the platform 100, 200 may send a follow-up text message to the phone, or e-mail may be sent to the customer's e-mail account.

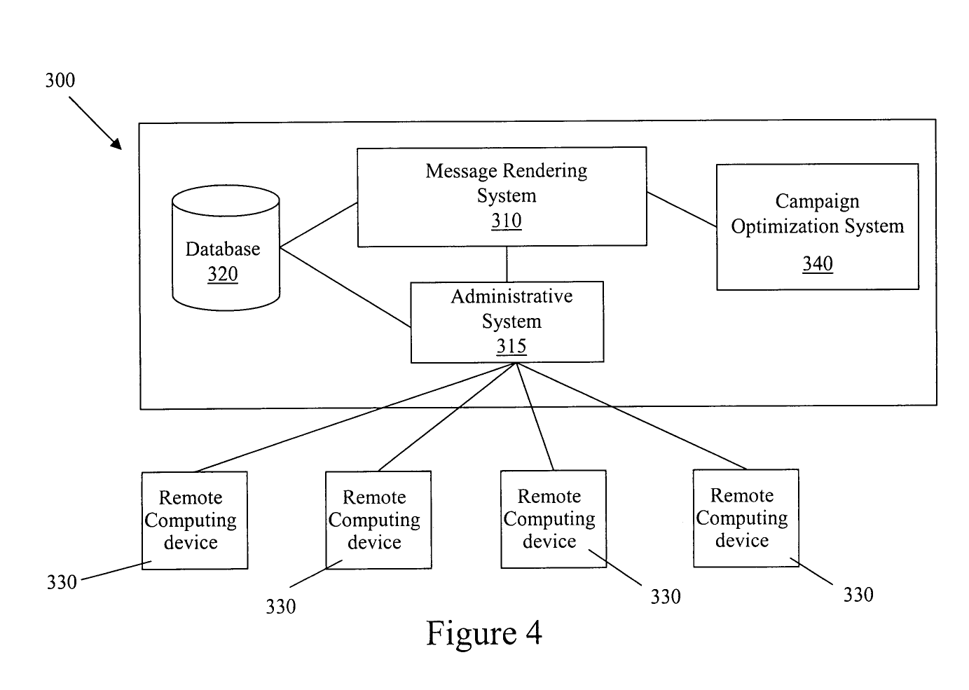

In an embodiment, as illustrated in FIG. 4, a platform 300 may be arranged to support co-authoring and multistage content development, where multiple internal users of the platform may write or edit content rules and segmentation conditions to be applied to the multiple communication channels. For example, when the platform 300 is used as a marketing tool, multiple users of the system may simultaneously access the platform 300 to manage data and write or edit rules and conditions. In one embodiment the platform 300 includes a message rendering system 310, an administrative system 315, a database 320, and a campaign optimization system 340. As shown in FIG. 4, the administrative system 315 is in communication with the message rendering system 310 and the database 320. Users of the system, such as marketing managers for example, may access the administrative system 315 to write or edit rules and conditions. In such an embodiment, the administrative system 315 may include a content management subsystem and rules and segmentation subsystem. The level of access provided to users may include direct access to the content management and rules and segmentation subsystems for directly writing and editing rules and conditions. For example, a rule may be written such that it applies to all communication channels and profiles or may be written such that it applies specifically to one communication channel or a segment of profiles. The platform 300 may be arranged such that users may access only the administrative system 310 and are restricted from accessing any other component of the platform 300. Alternatively, the platform 300 may be arranged such that users may access a number of components, such as the message rendering system 310 and database 320. The platform 300 may be accessible through a remote computing device 330. A remote computing device 330 may be, for example, a desktop computer, laptop computer, personal digital assistant, a web browser application, or the like. In one example, the platform 300 may be arranged to allow a remote computing device 330 to access the administrative system 315 through the internet, an intranet, a dedicated client-server connection, or the like. Additionally, the platform 300 may be offered as a web-based “software as a service” application to facilitate the adoption of the platform 300 by a company. A security layer may be included to control user access to the platform 300 and provide a secured environment to prevent unauthorized manipulation of rules and conditions. User access to the platform 300 or any component of the platform 300 may be controlled by unique user identification and passwords or other such methods. Additional security may be provided by the isolation of the administrative system 315 from the message rendering system 310. Such isolation makes it more difficult for an unauthorized user of the system to access the rules and conditions residing in content management and rules and segmentation subsystems. In an alternative embodiment, the administrative system 315 may reside within the message rendering system 310 with the security layer controlling access to the administrative system 315.

In addition to the content rules and segmentation conditions written and edited by users of the platform, logic may be included in the platform that generates rules based on the results of past messaging techniques and marketing campaigns. In one example, the logic may monitor a messaging technique, such as sending a marketing e-mail to a customer based on the number of times that customer has searched for a specific product on websites. If the logic determines that a customer's likeliness to purchase that product through a marketing e-mail dramatically increases after the customer has searched for the product at least five times, the logic may automatically generate a rule that prevents such marketing e-mails from being sent until the customer's website activity shows at least five searches for the product. The logic may be arranged such that rules are generated only when data collected and analyzed meets certain statistical benchmarks such as, for example, minimum data sample set, proper standard deviation, etc. Such functionality may be implemented using artificial intelligence software and techniques.

Marketing campaigns may be developed by users of the system such as marketing managers and optimized by the platform. The effectiveness of all marketing campaigns may be monitored by the platform by gathering each campaign's statistics, such as number of sales generated by each campaign and general response by customers receiving communications from the campaign. The statistics of each marketing campaign may be analyzed with statistical methods, such as multivariate methods and the like. The results of such analysis of comparable marketing campaigns may be evaluated by marketing managers to determine which campaigns are the most effective. Optionally, the platform may be arranged to compare the analysis results of comparable campaigns and continue only the campaigns that are statistically the most effective. In addition, the platform may be arranged to compare the statistical analysis of every campaign against established benchmarks and only continue the campaigns that meet or exceed the benchmarks. As shown in FIG. 4, the logic for optimizing marketing campaigns may be segregated into a campaign optimization system 340. Users may directly or indirectly edit the rules and other logic of the campaign optimization system 340. Optionally, the campaign optimization system 340 may be incorporated into the message rendering system 310.

Embodiments of a platform may be arranged to provide tools with interfaces that allow rules to be written and edited by non-technical employees. For example, a web-based graphic user interfaces may be provided to allow a user, such as a marketing manager, who has little knowledge of software code or applications to access the platform to manage the content for which the user is responsible. Because the logic of the platform can format and generate communications for multiple communication channels, the user only has to manage the content and need not be concerned with how a message is formatted for the multiple channels. However, in some cases the user may want to develop content that is specific to a channel and not rely on the platform's ability to format or transform content for multiple channels, i.e., the platform can be arranged such that a user may customize communications based on the communication channel. For example, a user may prefer a graphic message for delivery through the internet website channel and may prefer a text message when delivered through the mobile phone channel. The system may be arranged to allow the user to specify the preferred content for each channel.

Embodiments of the platforms used by a company may be utilized in different ways based on a user's job function within the company. For example, company executives may access the platform to view high-level reports on the effectiveness of marketing campaigns, efficiency of the different channels of communication, rate of increase in profiles stored in the platform, etc. Marketing managers may access the platform to write and edit rules, test proposed marketing campaigns, view detailed reports on activity and campaigns, etc. Production staff may access the platform to add, edit, and delete content such as text, graphics, audio files, etc. It will be understood that access to the platform may be restricted based on job title and responsibilities. For example, access to writing and editing rules may be limited to marketing managers, or access to high level reports may be limited to company executives.

In an embodiment, planning and analytic tools are provided as graphic user interfaces accessible to users though a web browser or other such internet and intranet tools. Alternatively such tools may be made available to a user by installing such tools on a user's computer or other such device. Such tools provide visual campaign planning and web analytics. Visual campaign planning tools allow a user, such as a marketing manager, to create or modify rules by dragging and dropping items into a visual campaign, thus defining relationships between each of the items and assigning production-related tasks to production staff members to generate correlating project schedules. Web analytic tools allow a marketing manager to track marketing campaigns by providing the marketing manager with accurate, actionable, and useful information on the results of marketing campaigns.

In an embodiment, tools are provided to facilitate marketing through the e-mail communication channel. Content management interfaces are provided to allow a non-technical marketing manager to create sophisticated communications with limited knowledge of HTML or similar type of code. Templates, modular content management, and menuing may be provided to facilitate the creation of content and the editing of that content. Segmentation and list management functionalities are provided to allow for the targeting of customers by creating lists through segmentation by customer fields (e.g., purchase history), online activity (e.g., e-mail, mobile, or web), and form responses (e.g., customer surveys). Once a segment is defined, content rules can be created that can be applied to content, and if a customer meets the criteria of the rules, content is communicated to that customer. Functionality is provided to facilitate the dynamic creation of e-mail content. Every e-mail communication to a customer may be customized and personalized dynamically to maximize its effectiveness for each customer. Tools to assure delivery may be provided. Such tools may optimize performance for delivery rates, inbox rates, and customer experience. A system user, such as a marketing manager, may preview e-mail messages across all major internet service providers (“ISP”), test e-mail messages against the most recent releases of spam filters, and track deliverability of campaigns for the major North American and International ISPs down to the folder level. This may include detection of the delivery of e-mail messages to bulk folders as opposed to an inbox of a customer.

In an embodiment, tools are provided to facilitate marketing through the mobile phone channel. Tools are provided so that marketing managers may create and manage interactive SMS messages through graphic user interfaces and message flow templates. The interface may be configured to guide a system user, such as a marketing manager, through the process of creating a campaign, while ensuring the published best practices of the Mobile Marketing Association are followed. Once a campaign is created, the marketing manager completes the process by assigning a shortcode and keyword to the campaign. Tools may be provided to enable web or e-mail content to be reformatted and sent to a mobile phone. The platform may be integrated with a wireless gateway provider to facilitate a large subscriber footprint with a reputation for time-to-market, quality message delivery, and attentive customer service.

In an embodiment, tools are provided to facilitate marketing through the internet website communication channel. Tools may be provided to facilitate the serving of relevant content. Serving relevant content to a website visitor is accomplished by storing and evaluating the past behavior of that visitor and applying that behavior as an indicator of the future interests of that visitor. Alternatively, content may be served by rules stored in the system. By anticipating the visitor's interest, personally relevant content may be dynamically served from the platform to the website, thereby extending the opportunity to communicate with the visitor. In an embodiment, the platform may directly serve content to the website or to a portion of the website. In another embodiment, the platform may provide suggestions to the website's server-side software. The server-side software may use such suggestions to search its own databases for content to be served to the visitor of the website. Such arrangements transparently enrich the visitor's website experience with the most targeted information and offer possible campaigns, including up-sell and cross-sell, that leverage the specific knowledge of the visitor's purchase history, search activity, e-mail activity, demographic profile, or geographic location. Tools may be provided to produce and host pages and forms within the application. Such tools facilitate a seamless and efficient back-end production process for marketing managers and front-end website experience for visitors.

Although the described embodiments generally set forth information or messages as being sent from the platform to customers, it will be understood that the platform is arranged to receive information and messages from customers. For example, a customer may send e-mail to the company in response to a question in an e-mail sent by the platform. The contents of this responsive e-mail may be evaluated to determine the answer to the question, and any pertinent information may be associated with the customer and stored in the message rendering system. In another example, which will be further described herein, the activities of visitors to a website may be monitored, associated with a customer, and stored in the message rendering system.

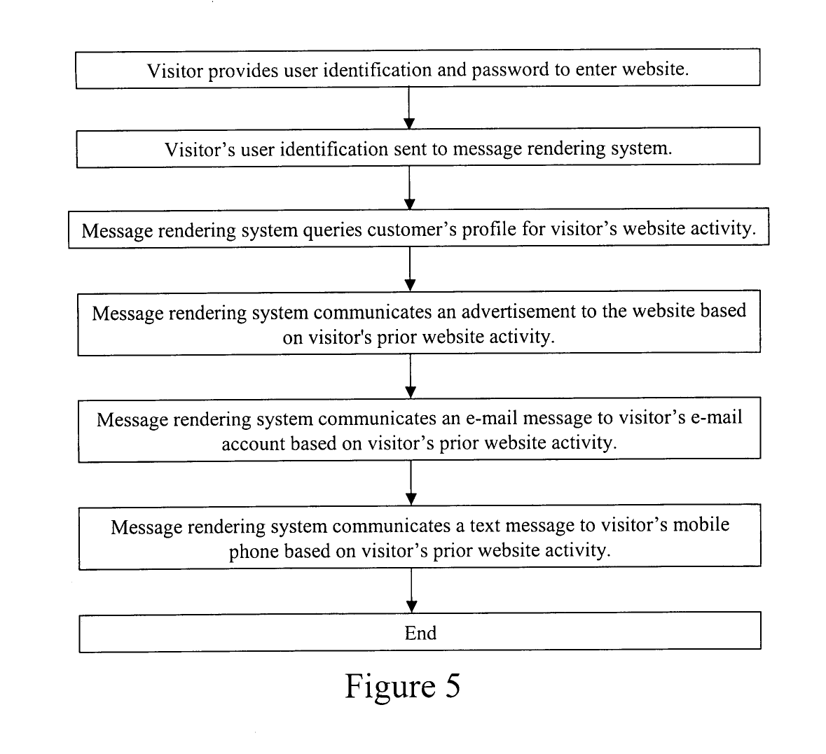

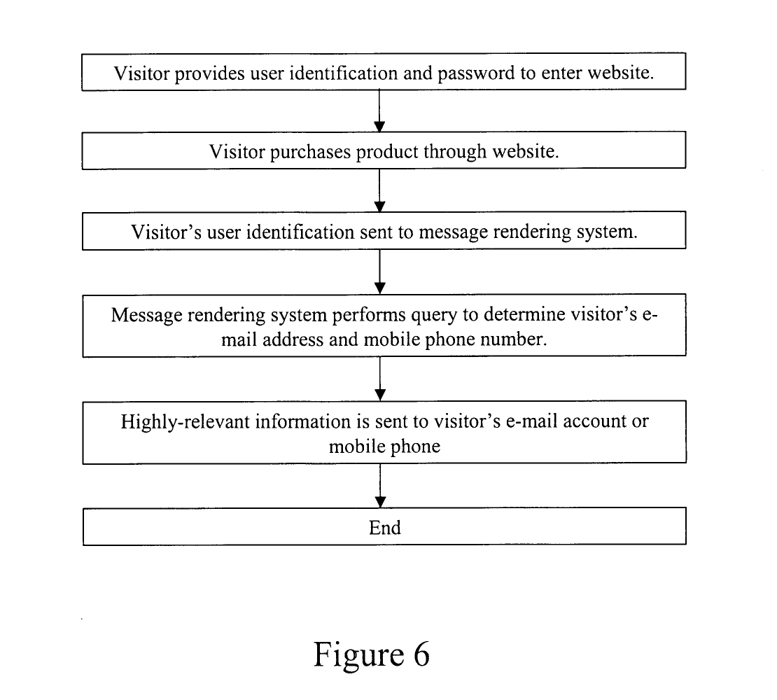

In an embodiment, a method is provided to utilize the platform to provide highly relevant and customized content to a visitor of a website. An example of such a method is illustrated in FIGS. 5 and 6. In these examples, when a website is arranged such that access to the website is allowed only when a visitor provides a user identification and a password, a known profile for each visitor may be stored in the message rendering system. The visitor's past and current activity on the website also is stored in the message rendering system and used to provide highly relevant content to the visitor through multiple communication channels. A visitor to a website may be identified by methods other than recognizing a user identification and password. For websites that do not require a user identification and password, a visitor may be identified by an HTTP cookie residing on the visitor's computer from a past visit to the website. In another example, the visitor may be recognized because the visitor accessed the website from a hyperlink embedded in an e-mail sent to the visitor.

With reference to FIG. 5, an example of using the platform to provide highly relevant and customized content to a visitor of a website is described. A visitor enters a retail website by providing a unique user identification and password. The user identification is communicated to the message rendering system, which queries that customer's profile for information on the visitor. The query returns information on the visitor, such as the last product search performed on the retail website by the visitor and the last product purchased by the visitor on the website. Based on this returned information, the message rendering system populates a portion of the website with relevant content. The relevant content chosen may be an accessory to the last item purchased by the visitor or may be the best price currently available for the last product searched for by the visitor. In addition, the message rendering system may communicate an e-mail message to the visitor's e-mail account and send a text message to the visitor's mobile phone with information regarding the accessory product or best price on a previously searched product. Such a method provides multiple messages to the visitor and provides a company with multiple chances to sell a product.

One example of the method illustrated in FIG. 5 may be described with reference to a website that retails electronic devices. A frequent visitor to the website may perform several repeat searches over a period of time, waiting for a lower price for a particular digital music player. These product searches are stored in the message rendering system and associated with the specific visitor's profile. The visitor may grow frustrated as the price of the digital music player remains constant and stop performing the search during visits to the website. However, the logic of the message rendering system detects the pattern of searches by the visitor and queries the price of the digital music player each time the visitor logs onto the website. Eventually, the price drops, and the message rendering system dynamically delivers content to the website showing the visitor the digital music player at its lowered price. The visitor is presented with information this is highly relevant, and the retail website is presented with an additional opportunity to sell a product. If the visitor does not act on the purchase, e-mail with the new lowered price is optionally communicated to the visitor's e-mail account and a text message with the new lower price is communicated to the visitor's mobile phone. These additional communications may result in a sale if the visitor did not act on the content delivered to the website or if the visitor was not yet prepared to buy at the time of the last visit to the website.

FIG. 6 illustrates another method for providing highly relevant and customized content to a visitor to a website. When a visitor to a website purchases an item on the website, additional communications may be sent across multiple channels related to the purchase. In one example, once a visitor purchases an item on a website, the identification of the visitor and the purchased item may be communicated to the message rendering system. The message rendering system performs a query to determine the visitor's e-mail address and mobile phone number. The message rendering system may then communicate highly relevant information to the visitor such as, for example, sending a receipt for the purchase to the visitor's e-mail account, thereby avoiding the need for the visitor to print out a receipt from the website; sending an e-mail with warranty information on the product to the visitor's e-mail account; and sending a text message to the visitor's mobile phone on the day the product is shipped from the warehouse. Such communications may eliminate the need for the visitor to write down or print information during the on-line sale. The visitor at his or her convenience may access such information sent to a mobile phone or e-mail account. The method may optionally include the step of the visitor selecting a preferred method for receiving such communications.

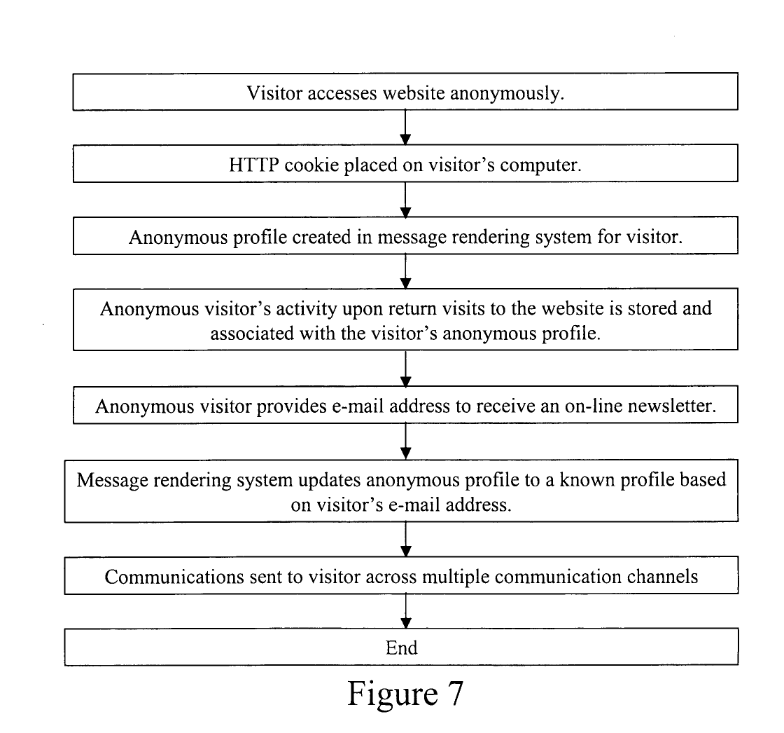

FIG. 7 illustrates another method for providing highly relevant and customized content to a visitor of a website. Many websites do not require that visitors provide a user identification or password to access the website; therefore, a known profile with the visitor's identification as described above cannot be initially stored in the message rendering system. In such an arrangement, information still may be gathered regarding the visitor. The name or identity of the visitor may not be known; however, the repeat activity of the unknown visitor may still be recorded and stored in an anonymous profile stored in the message rendering system. Anonymous visitors to a website may be tracked by placing an HTTP cookie on the anonymous visitor's computer, provided the internet application settings on the visitor's computer allow for the placement of such a cookie. This cookie is used to identify the visitor with the anonymous profile upon return visits to the website and to store the visitor's website activity in the message rendering system. Therefore, as described above, a message rendering system may dynamically deliver content to the website based on the anonymous visitor's past usage history. Another method of tracking an anonymous website visitor is to capture the IP address associated with the computer used to access the website. Upon repeat visits to the website, the IP address may identify the anonymous visitor.

As the anonymous visitor continues to return to the website, the visitor may eventually complete a survey or sign-up for an online newsletter using an e-mail address. The formerly anonymous visitor now becomes a known visitor, and the stored history of this visitor may be merged with the newly-gathered information to form a robust known profile to be stored in the message rendering system. Once the known profile is established, communications may be sent to the visitor through multiple communication channels, and such communications may be based on activities stored while the visitor was anonymous, as well as after the visitor became known.

In another embodiment, the message rendering system may periodically or continuously compare database records for matching data to determine if multiple profiles are directed to the same customer. For example, one profile for an individual may include a mobile phone number and stored website activity, while another profile for that individual may include an e-mail address and stored website activity. Two profiles have been stored in the database because the individual provided a mobile phone number during one transaction and an e-mail address for another transaction. If in a subsequent transaction, the individual provides both an e-mail address and mobile phone number, the content management system may search the database for matching e-mail addresses and mobile phone numbers and merge the profiles that have matching e-mail accounts or mobile phone numbers. This merging of profiles may result in a much more robust profile and allow for communications with the customer across e-mail, mobile, and internet website communication channels.

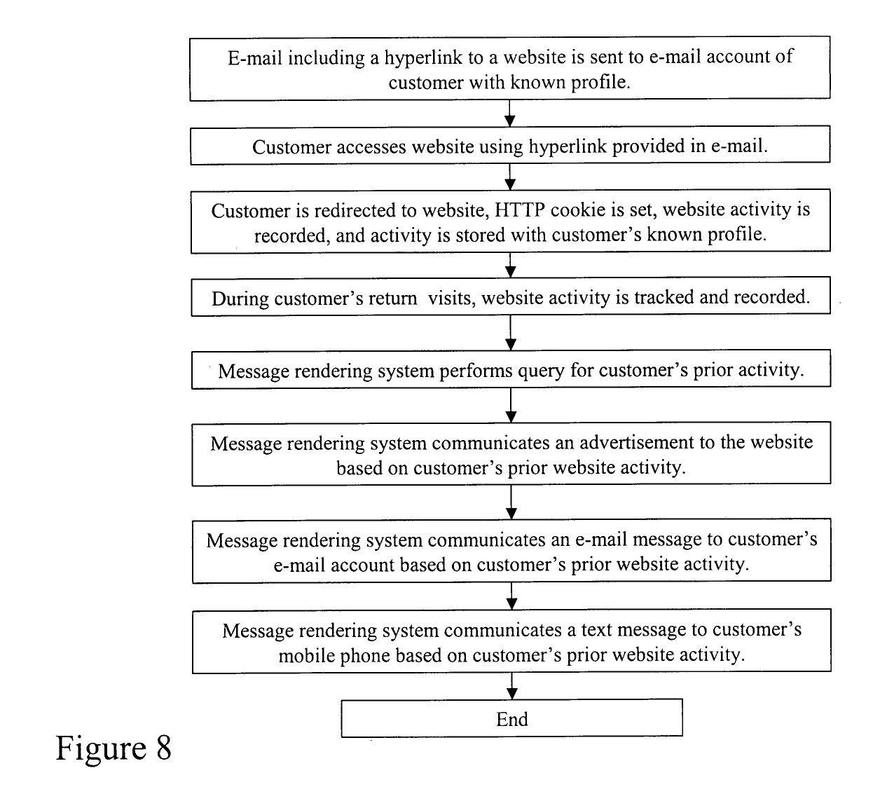

FIG. 8 illustrates a method of creating a robust known profile within a platform. It is typical for a company to have an e-mail address for a customer but have limited ability to record and store that customer's website activity. In such a situation, a method may be utilized to link a customer's website activity to that customer's profile. An e-mail may be sent to the customer, in which the e-mail includes a hyperlink to a website. The hyperlink may be formatted in such a way that the customer is redirected to the website and is identifiable by the platform when the customer uses the link to access the website. Therefore, when the customer accesses the website using the hyperlink, the customer's activity on the website can be recorded and stored by the platform even when the website does not require a user name or password. In addition, an HTTP cookie can be placed on the customer's computer, provided the internet application settings on the visitor's computer allow for the placement of such a cookie, so that the customer may be identified during return visits to the website, regardless of how the customer accesses the website. As described above, content highly relevant to the customer and based on the customer's past website activity may be provided to the website whenever the customer returns to the website. In addition, website activity may be used to generate highly relevant communications with the customer across multiple channels, such as mobile phone and email.

Embodiments of the invention have been described above and, obviously, modifications and alterations will occur to others upon the reading and understanding of this specification. The claims as follows are intended to include all modifications and alterations insofar as they come within the scope of the claims or the equivalent thereof.

What is claimed is:

1. A method for communicating with users across multiple communication channels from a single platform comprising:
gathering data related to a first user;
storing the gathered data;
accessing the stored data to determine whether a message should be sent to the first user;
accessing the stored data to determine what communication channel should be used send the message to the first user;
formatting the message for the determined communication channel; and
sending the message to the first user through the determined communication channel.

2. The method of claim 1, further comprising storing the data in a data store.

3. The method of claim 1, where the multiple communication channels includes at least one of an electronic mail communication channel, a mobile phone communication channel, an internet website communication channel, or an interactive television communication channel.

4. The method of claim 1, further comprising evaluating rules to determine that a communication is to be sent to the first user.

5. The method of claim 4, further comprising storing rules in a subsystem.

6. The method of claim 5, further comprising storing the data in the subsystem.

7. The method of claim 4, where the subsystem is one of a content management system, an extensible profile system, an activity and response system, or a rules and segmentation system.

8. The method of claim 1, further comprising formatting the message through a multiple channel rendering engine.

9. The method of claim 8, further comprising sending the message through a messaging engine.

10. A method for associating a stored profile of a user of an internet website with the user comprising:
detecting the user accessing the internet website;
placing an HTTP cookie on the user's computer;
creating an anonymous profile of the user in a data store;
storing the user's website activity in the data store;
associating the user's website activity with the anonymous profile;
monitoring the user's activity for personal identification data;
associating the personal identification data with the anonymous profile; and
converting the anonymous profile to a first known profile.

11. The method of claim 10, where the data store is a database.

12. The method of claim 10, where the data store is a subsystem.

13. The method of claim 10, further comprising:
searching the data store for known profiles with personal identification information that matches the personal identification data of the first user profile; and
merging the first user profile with a second user profile with personal identification information that matches the personal identification data of the first user profile.

14. The method of claim 10, further comprising sending a relevant message to the user based on the user's website activity.

15. The method of claim 14, further comprising selecting a communication channel from multiple communication channels by which to send the relevant message to the user.

16. The method of claim 15, further comprising formatting the relevant message based on the selected communication channel.

17. A system for selectively communicating with a user across one of at least two communication channels comprising:
a data store;
a rendering engine in communication with the data store for selectively rendering a message for one of the at least two communication channels; and
a first subsystem in communication with the data store and the rendering engine, the first subsystem including logic for generating the selectively rendered message;
wherein the system is distributed across a single platform.

18. The system of claim 17, where the one of at least two communication channels includes an electronic mail communication channel, a mobile phone communication channel, an internet website communication channel, or an interactive television communication channel.

19. The system of claim 17, further comprising a messenger engine in communication with the rendering engine for delivering the message to the user.

20. The system of claim 17, where the first subsystem is either a content management system, an extensible profile system, an activity and response system, or a rules and segmentation system.
